(19) United States
(12) Patent Application Publication
(10) Pub. No.: US 2009/0241064 A1
(43) Pub. Date: Sep. 24, 2009

(54) USER INTERFACE FOR INFORMATION PUBLISHING AND USER ADMINISTRATION

(76) Inventor: John James Harris, East Fremantle (AU)

Correspondence Address: NIXON & VANDERHYE, PC, 901 NORTH GLEBE ROAD, 11TH FLOOR, ARLINGTON, VA, 22203, US

(21) Appl. No.: 12/051,879

(22) Filed: Mar. 20, 2008

(51) Int. Cl. G06F 3/048

(52) U.S. Cl. 715/841

(57) ABSTRACT

A user interface for an information publishing and user administration comprising a first screen area, a second screen area and a third screen area. The first portion of the first screen area includes an interface for a user to select either a group of users from a data store or a type of data to be published and the selection is displayed in the first screen area. The second screen area displays an interface to select one or more groups of users whose members may either have a relationship with the selected user from the first display area or be the recipient of the selected data from the first screen area. A third screen portion displays selected members from the second screen area. The user interface creates a relationship in the data store between the member selected in the first screen area and the members in the third screen area or to transmit the data selected in the first screen area to the members in the third screen area.

### FIELD OF THE INVENTION

The present invention relates to a user interface for a system that allows information to be published to the users of the system and allows also administration of those users.

### BACKGROUND TO THE INVENTION

Many software systems are available to assist with publishing electronic information. Such systems also have means available to store information regarding the users of the system and to provide administration functions. The present invention relates to a system that allows publishing of information, control of access to the information and administration of the system users in a simple user interface. The user interface provides ease of use such that the system can be implemented across a large number of users without requiring significant training of the users.

References to prior art in this specification are provided for illustrative purposes only and are not to be taken as an admission that such prior art is part of the common general knowledge in Australia or elsewhere.

### SUMMARY OF THE INVENTION

According to one aspect of the present invention, there is provided a user interface for an information publishing and user administration system comprising:

a first screen area including a first portion and a second portion, the first portion including means for a user to select either:
a group of users from a data store, in which case the members of that group are displayed in the second portion; or
a type of data to be published, in which case data to be published of said type is displayed in the second portion;

such that selection of one of said members or data in the second portion causes display of information regarding said member or data to be displayed in the first screen area;

a second screen area including a first portion and a second portion wherein the first portion has means to select one or more groups of users whose members may either:
have a relationship with the selected user from the second portion of the first screen area; or
be the recipient of the selected data from the second portion of the first screen area;

such that selection of one of said groups in the first portion of the second screen area causes display of the members of said selected group in the second portion of the second screen area;

a third screen portion wherein members displayed in the second portion of the second screen area can be selected or deselected such that selection causes the selected member to appear in the third screen area and de-selection causes the member to be removed from the third screen area; and

an activation means whereby selection of the activation means either:
creates a relationship in the data store between the member selected in the second portion of the first screen area and the members in the third screen area; or
transmits the data selected in the second portion of the first screen area to the members in the third screen area.

Preferably, the means to select the group of users or type of data to be published in the first portion of the first screen area comprises a set of buttons, each button of the first set referencing a group or a data type.

The display of members of the group or data of the selected type preferably comprises a first list displayed in the second portion of the first screen area. The display of the members of the selected group in the second portion of the second screen area also preferably comprises a second list displayed in the second portion. Further, members selected from the second list in the second screen area are preferably displayed in a third list in the third screen area.

In a preferred embodiment, selection or de-selection of members displayed in the second portion of the second screen area is effected by selector buttons provided adjacent members in the second list in the second screen area and de-selection buttons provided adjacent the members in the third list in the third screen area.

In one embodiment, the activation means comprises a save button in the first screen area. Means are also provided to create new members or new data to be published in second portion of the first screen area. Preferably, the means to create new members or new data comprises a new button in the first screen area.

In a preferred embodiment the user interface is accessible via a browser interface and one or more of the users is provided with a website and operation of the activation means causes publication of the data on the websites of the users listed on the third screen area.

A link may be provided adjacent each of the users listed on the third screen area and selection of the link causes display of the website of the user.

The data to be published may also be transmitted to the users as email.

In a preferred embodiment the first screen area comprises a central screen area, the second screen area comprises a left screen area and the third screen area comprises a right screen area. Preferably the first portion of the first screen area is located adjacent the top of the first screen area and the second portion of the first screen area is located below the first portion of the first screen area. The first portion of the second screen area is also preferably located adjacent the top of the second screen area and the second portion of the second screen area is located below the first portion of the second screen area.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of the user interface for an information publishing and user administration system, given by way of example only, with reference to the accompanying drawings, in which:

FIG. 1 is view of a first screen area of the user interface of the present invention upon selection of a group from the first portion of the first screen area;

FIG. 2 is view of the first, second and third screen areas of the user interface of the present invention upon selection of a member from the second portion of the first screen area;

FIG. 3 is a view of the user interface after selection of members from the of the second screen area;

FIG. 4 is view of a first screen area of the user interface of the present invention upon selection of a type of data from the first portion of the first screen area;

FIG. 5 is view of the first, second and third screen areas of the user interface of the present invention upon selection of data to be published from the second portion of the first screen area;

FIG. 6 is a view of the user interface after expansion of a group of members in the third screen area;

FIG. 7 is an example of a webpage of a user on which information relevant to the user can be published;

FIG. 8 is a view of the user interface in which an data published, being an assigned activity is displayed in the first screen area; and

FIG. 9 is a view of the user interface in which data from a users website related to the assigned activity is displayed in the first screen area.

### DETAILED DESCRIPTION OF PREFERRED EMBODIMENTS

The user interface of the present invention is provided to allow functionality including publishing of information to one or more users of the system. Details of the users of the system and groups into which users are divided are stored in a data store. The user interface allows also control of the information contained in the data store including details of the users and groups and relationships between the users and groups.

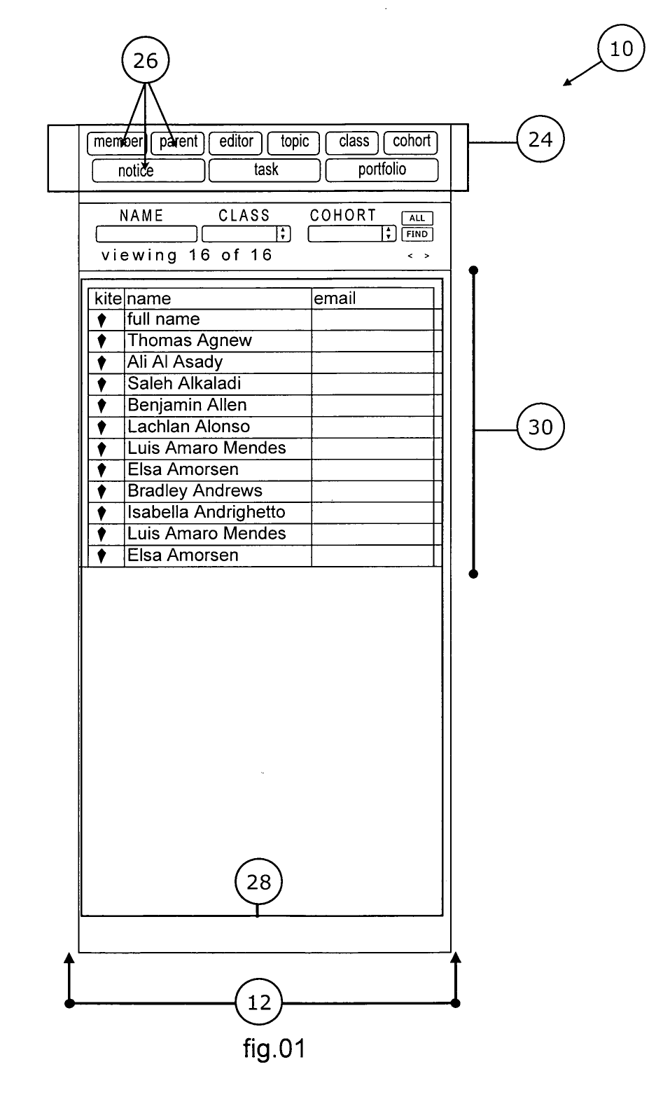

A preferred embodiment of user interface 10 in accordance with the invention is illustrated in FIGS. 1 to 9. The user interface 10 is accessed via web browser software. The embodiment shown in the Figures uses the example of a school, wherein the users include students, teachers and parents. Students may be grouped into appropriate groups such as classes and years. Relationships are required to be stored in the database between users and groups (i.e. between users and other users, users and groups or groups and other groups). For example, student users are grouped into classes and years. Teachers are related to classes of students and parents are related to students.

The user interface 10 comprises a first screen area 12, a second screen area 14 and a third screen area 16. In the embodiment shown, the user interface 10 comprises an area displayed on a computer screen divided generally into three areas. The first screen area 12 comprises a central area 18 (referred to in the example as the ‘focus’ area), the second screen area comprises a left screen area 20 (referred to in the example as the ‘assembly’ area) and the third screen area 16 comprises a right screen area 22 (referred to in the example as the ‘audience’ area).

The central screen area 18 comprises a first portion 24 adjacent the top in which is provided means to select either a group of users or a type of data to be published. The means comprises a first set of buttons 26. Some of the buttons 26 reference groups of users, such as teachers, class or year. Other buttons reference types of data that can be published to users such as notices or homework information to be published on webpages accessible by those users.

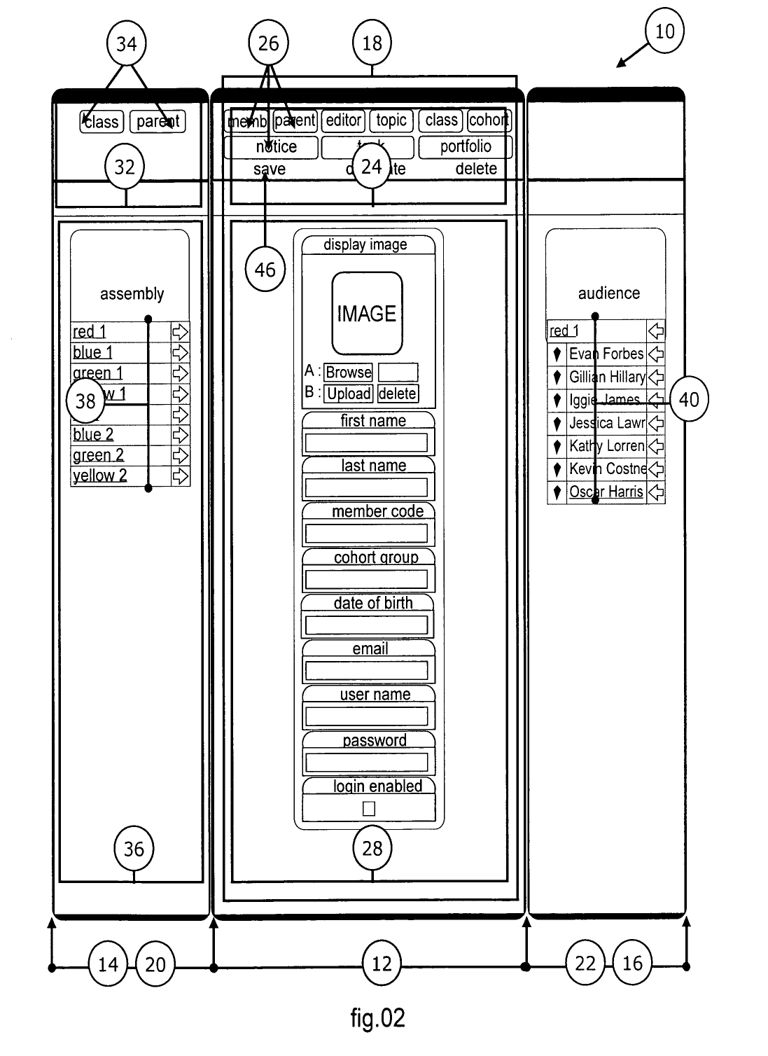

The central screen area 18 also includes a second portion 28 located below the first portion 24. The second portion 28 displays information based on selections made by the operator in the first portion 24. In the case of the operator selecting a button 26 referencing a group of users, the second portion 28 then displays a first list 30 of the users currently defined in that group. FIG. 1 shows an example in which the student button is selected and the second portion 28 of the central screen area 18 displays a first list 30 of the students currently in the data store. Similarly, if the teacher button was selected, the first list 30 would display the teachers in the data store. The first list 30 of students is selectable by the operator such that selection of one of the entries in the first list 30 results in the details of that user being displayed in the second portion 28 of the central screen area 18. The results of such a selection can be seen in the example in FIG. 2. The second portion 28 of the central screen area 18 shows details such as name, address, date of birth and other relevant details. Selection of a user from the first list 30 in the second portion 28 of the central screen area 18 also results in the display of means to select users or groups in a first portion 32 of the left screen area 20. The first portion 32 of the left screen area 20 is located at the top of the left screen area 20 as can be seen in FIG. 2. The means to select users or groups comprises a second set of buttons 34 with references to users or groups that may be related to the selected user in the central screen area 18. In the example shown in FIG. 2, the buttons 34 include class and parent. That is, the student selected in the central screen area 18 may belong to a class recorded in the data store and will have parents recorded in the data store with whom a relationship is to be recorded.

Selection of one of the buttons 34 results in a second list 38 being displayed in a second portion 36 of the second screen area 20 of the users belonging to the selected group, in this example being classes or parents. FIG. 2 shows a second list 38 of classes displayed on selection of the class button.

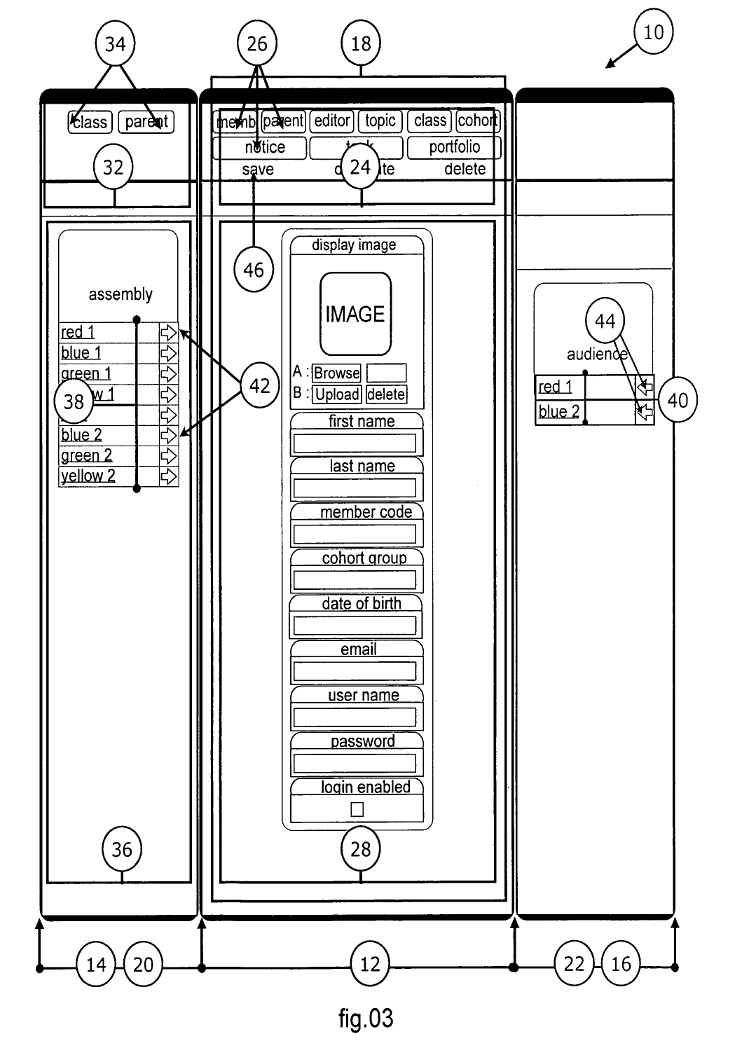

The right screen area 22 is provided to show users selected from the second list 38. Means are provided to allows users of the second list 38 to be either selected or de-selected. Selection results in the user being displayed in a third list 40 in the right screen area 22 and de-selection results in the user being removed from the third list 40. FIG. 3 shows an example of two classes being selected from the second list 38 and added to the third list 40. The means to select or deselect in the embodiment shown comprises select buttons 42 alongside users on the second list 38 and de-select buttons 44 alongside users on the third list 40.

The user interface 10 also includes an activation means to effect the changes set up in the central, left and right screen areas 18, 20 and 22. The activation means comprises a save button 46 in the central screen area 18. In the example shown in FIG. 3, selection of the save button 46 causes the relationships defined to be stored to the data store. That is, in this example, the selected student in the central screen area 18 is stored as being part of the selected classes in the left screen area 20. Any subsequent viewing of that student's details by selecting the student from the first list 30 in the central screen area 18 and then selecting classes in the left screen area 20 will result in these associated classes appearing in the right screen area 22 as existing relationships.

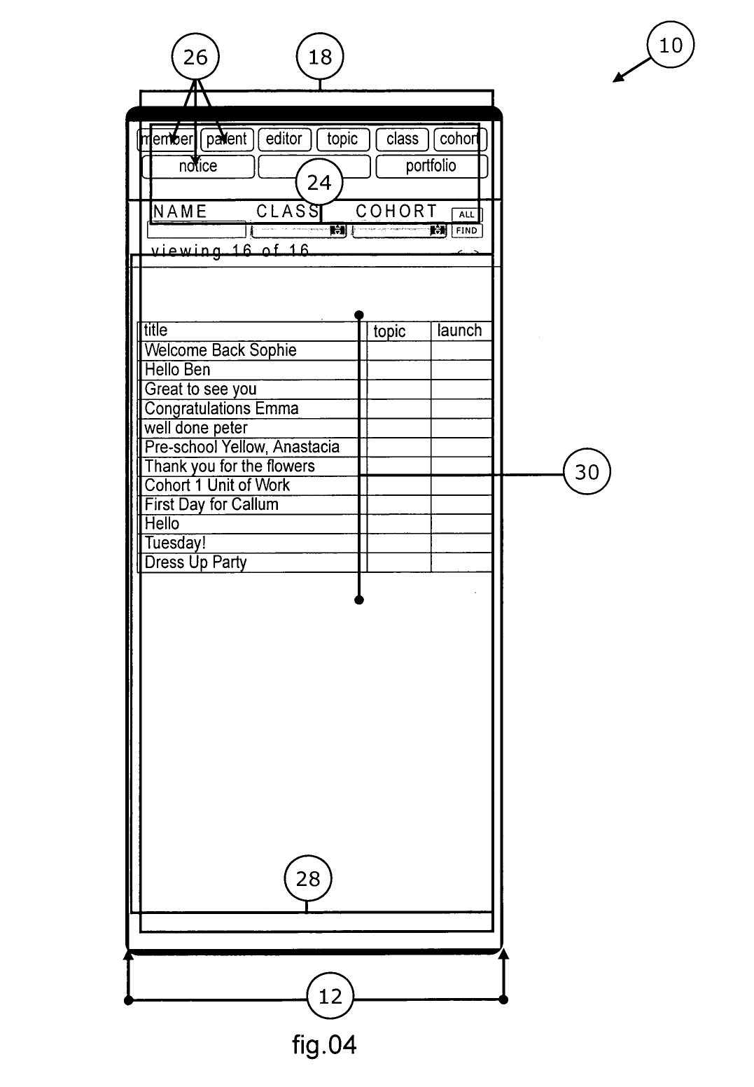

As described previously, the user interface 10 also allows publishing of data to users of the system. Such data publishing is perform by actions in the same manner as described previously for setting up relationships between users and groups. FIGS. 4 to 6 show such an operation.

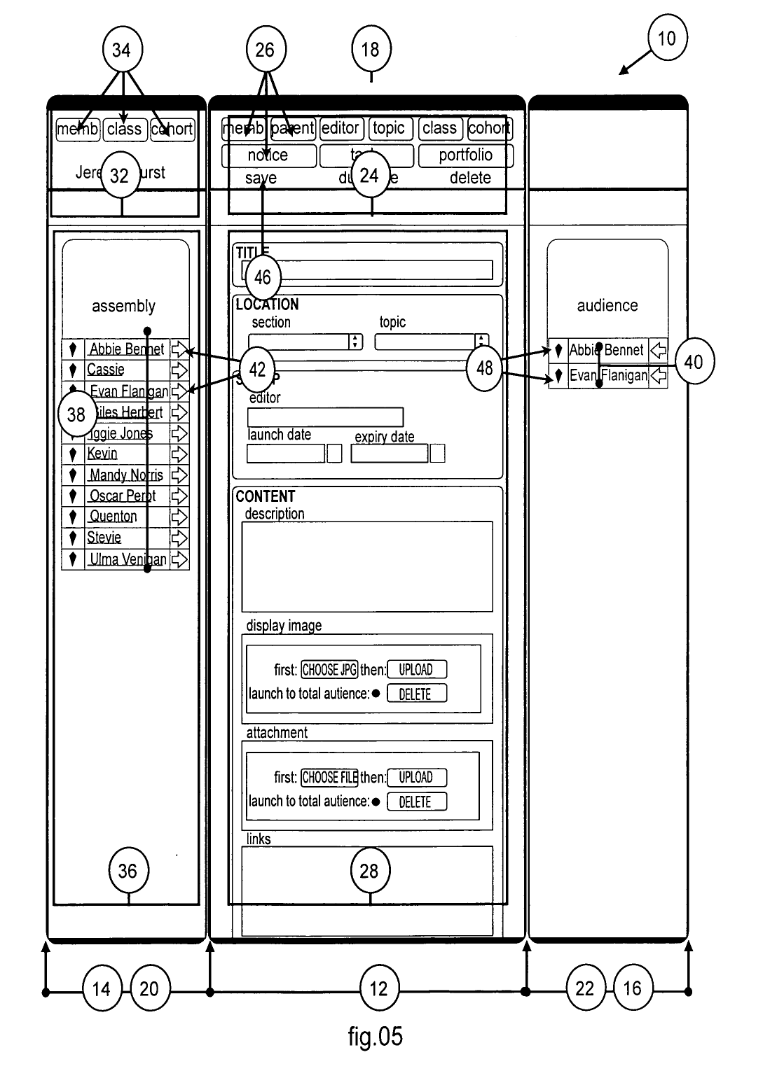

FIG. 4 shows the display of notices that have been published or are to be published in the first list 30 in the central screen area 18 by selection of the notices button from the first portion 24 of the central screen area 18. Selection of one of the notices from the first list 30 causes details of the notice to be displayed in the second portion 28 of the central screen area 18 as shown in FIG. 5. Users of the system can be provided with their own website and the notices generated for display are intended to be published on these websites. The second portion 28 of the central screen area 18 displays details of the selected notice, which can be edited prior to publishing.

As described previously, the first portion 32 of the left screen area 20 includes a second set of buttons 34 for selection users or groups, which in this case are the possible recipients of the data to be published. Selection of one of the second set of buttons 34 causes the display of the relevant users in the second list 38, which can then be selected for display in the third list 40 of the right screen area 22, or deselected as described previously. FIG. 5 shows an example in which two students have been selected to be the recipients of the data to be published. On activation via the save button, the notice is published to the websites of those students.

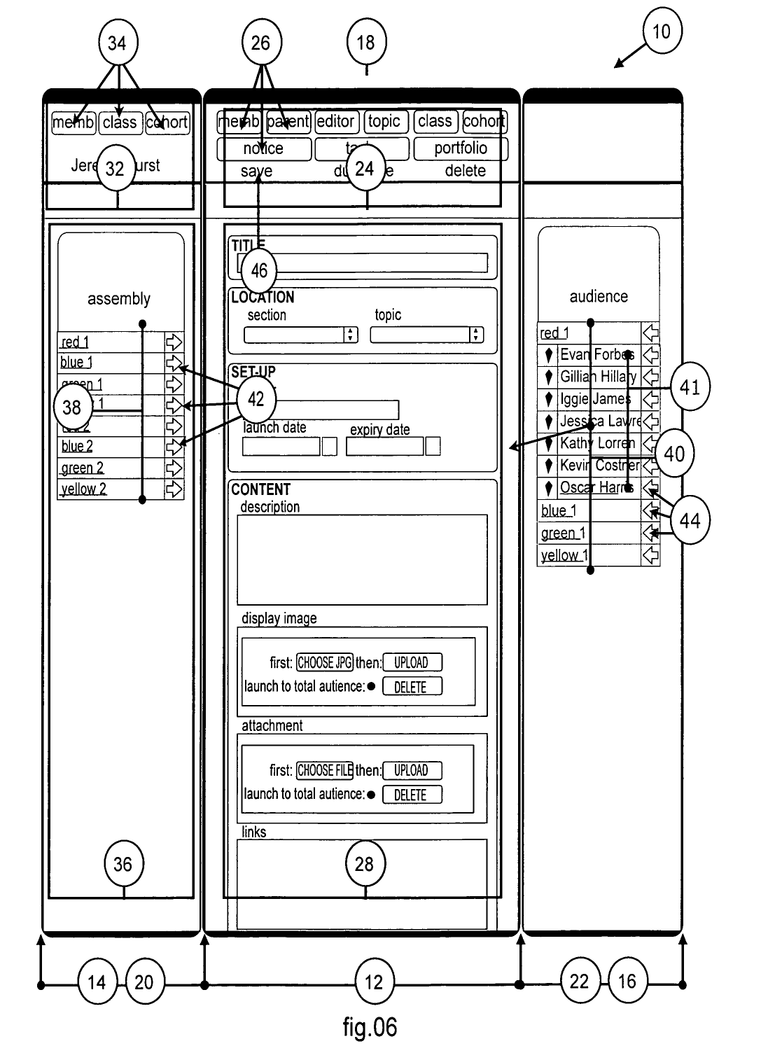

The user interface 10 also includes means to expand groups listed in either the second or third lists 38 and 40. FIG. 6 shows an example in which a project is selected in the central screen area 18 and classes are selected for display in the second list 38 in the left screen area 20. In the example shown, two classes have been selected for display in the third list 40 in the right screen area 22. By selecting one of the groups from the third list 40 (i.e. a class name), the members of that group (i.e. the students) are displayed as a sub-list 41 as can be seen in FIG. 6.

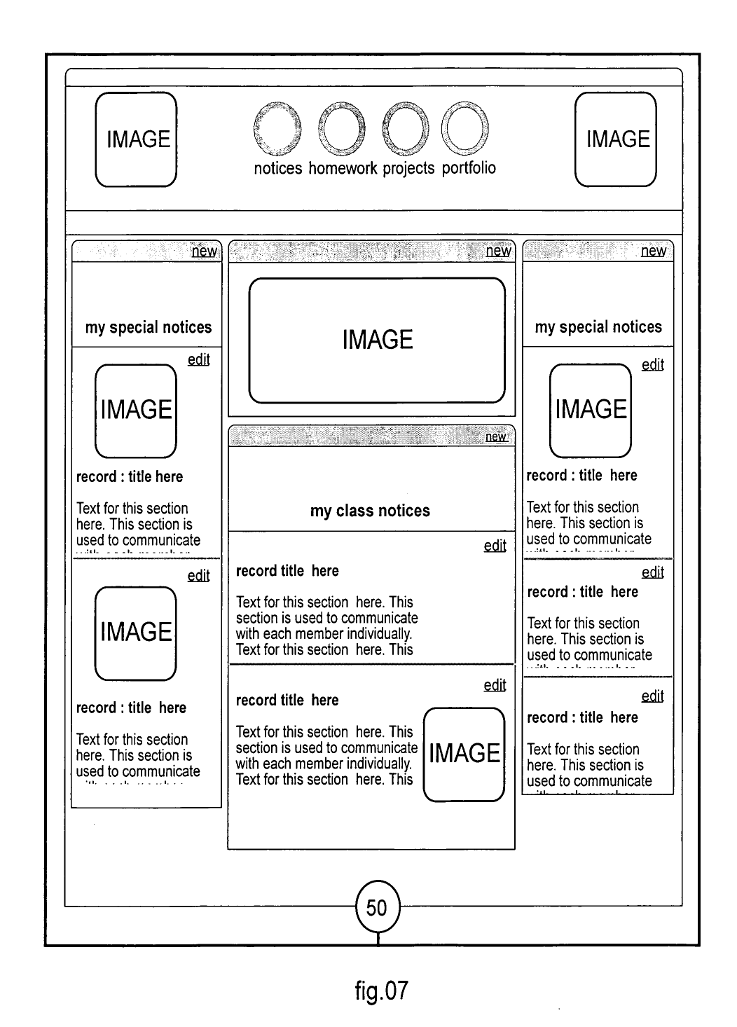

The websites 50 of the users, in this case students, can also be viewed by links 48 provided adjacent each user in the third list 40. These links 48 allow the person publishing the information to go direct to the website 50 and view the published data. An example of such a website 50 is shown in FIG. 7. The website may have different pages on which are displayed published data of different types. In the example shown, the website has pages for notices, homework and projects on which are published data of these types as selected in the central screen area 18 of the user interface 10.

The websites 50 has one or more areas on which data published by other users is displayed and one or more further areas in which related data published by the user of the website can be displayed. That is, if a user such as a teacher publishes information such as a project for the student, this appears on a designated area of the student's website. A further area is available for the student to publish data related to the data published by the teacher. For example, a teacher may then published information regarding an assigned activity which appears on the student's website and the student publishes their related data, being their activity results, on their website.

The publication of related data by the user of the website can also be viewed via the central screen area 18 of the user interface. The user interface 10 is arranged such that when published data is displayed in the second portion 28 of the central screen area 18, selecting a user from the third list 40 causes related data from the selected users website 50 to be displayed in the second portion of the central screen area 18.

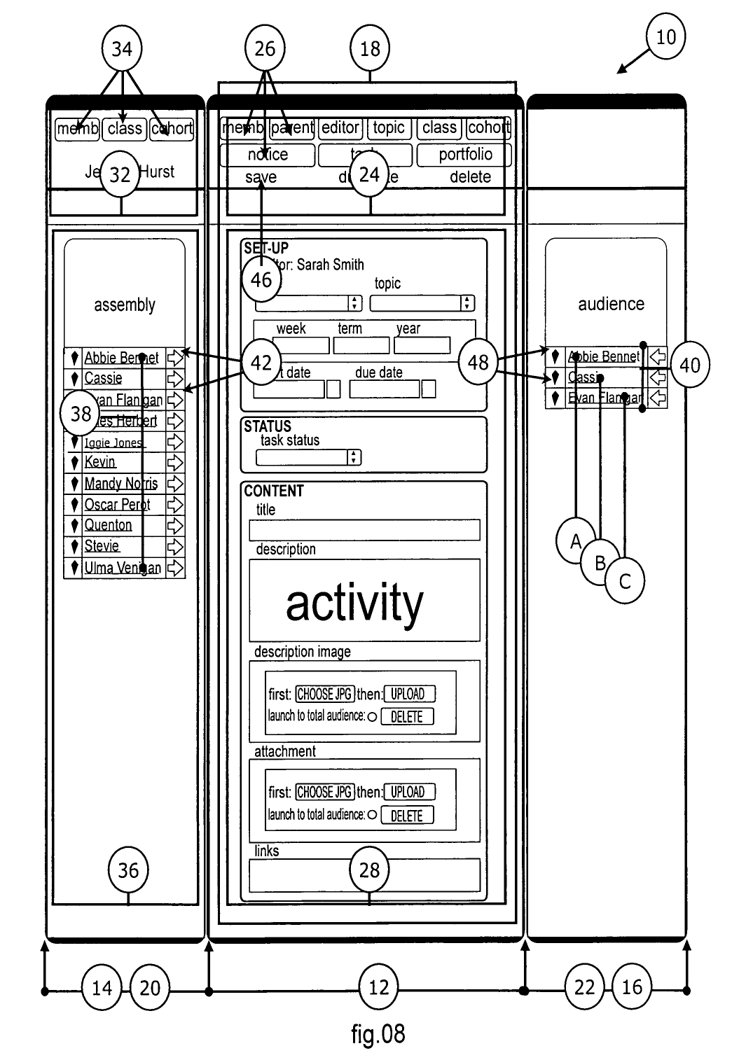

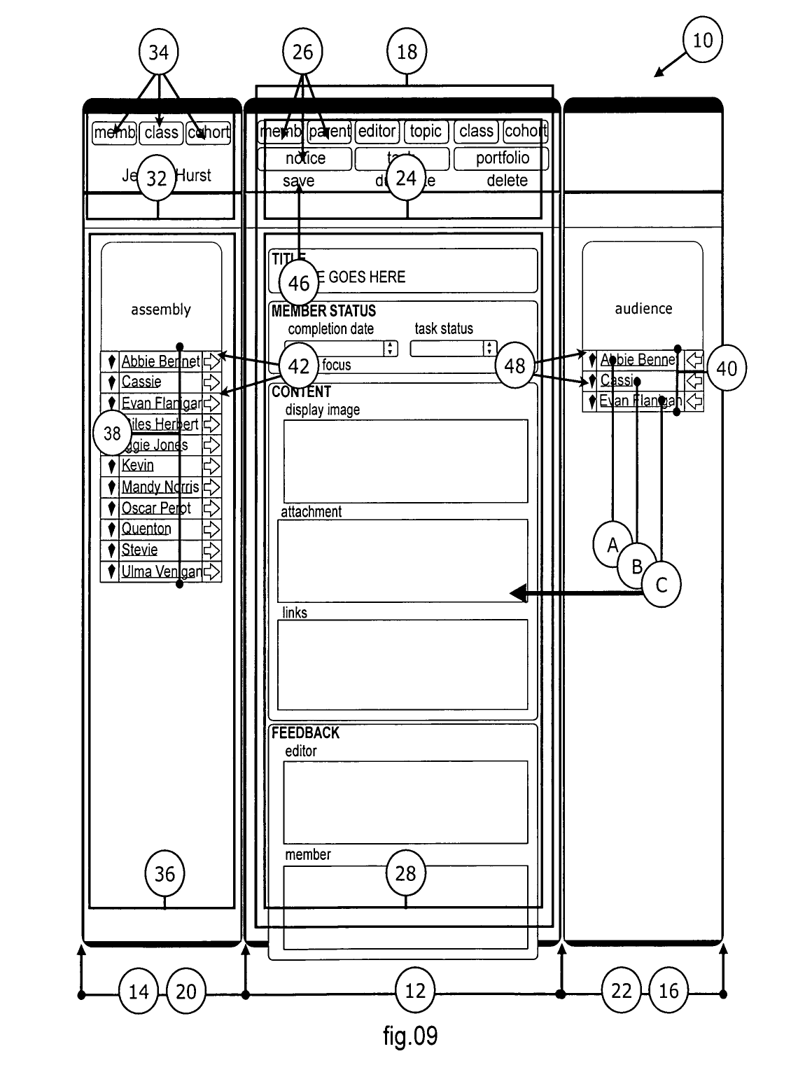

FIGS. 8 and 9 shows such an example. In FIG. 8, the central screen area 18 displays the details of an activity which has been published to websites of users displayed in the third list 40 on the right screen area 22. By selecting users from the third list 40, the related data from their websites (being their activity results) is displayed in the central screen area 18 (referred to in the Figure as the ‘portal’). In this way, users such as teachers can easily track the activities of students on the projects assigned to them.

While this example shows the data to be published as a notice published on a website 50, the data may be in other forms. For example, the data may be published as an email wherein the email is transmitted to the selected recipients in the third list 40 in the right screen area 22.

In each of the examples shown above of publishing data and setting up relationships between users and groups, the user interface 10 is also provided with means to create new users, groups or data to be published. A new button 52 is provided in the central screen area 18 to add new users, groups or data to be published into the first list 30 in the central screen area 18. The newly added user, group or data can then be selected and details edited. A delete button 54 is also provided to delete users, groups or data from the data store.

The functionality provided by the user interface 10 as shown in the examples in FIGS. 1 to 6 will be provided to only selected users. In the examples shown, it is expected that teachers will have access to the user interface 10 of FIGS. 1 to 6 and students and parents will have access only to their websites 50. Access is controlled based on a login and password provided to each user.

It will be readily apparent to persons skilled in the relevant arts that various modifications and improvements may be made to the foregoing embodiments, in addition to those already described, without departing from the basic inventive concepts of the present invention. Therefore, it will be appreciated that the scope of the invention is not limited to the specific embodiments described and is to be determined from the appended claims.

1. A user interface for an information publishing and user administration system comprising:
a first screen area including a first portion and a second portion, the first portion including a selection device for a user to select either:
a group of users from a data store, in which case the members of that group are displayed in the second portion; or
a type of data to be published, in which case the data to be published of said type is displayed in the second portion;
such that the selection of one of said members or data in the second portion causes display of information regarding said member or data to be displayed in the first screen area;
a second screen area including a first portion and a second portion wherein the first portion has a device to select one or more groups of users whose members may either:
have a relationship with the selected user from the second portion of the first screen area; or
be the recipient of the selected data from the second portion of the first screen area;
such that selection of one of said groups in the first portion of the second screen area causes display of the members of said selected group in the second portion of the second screen area;
a third screen portion wherein members displayed in the second portion of the second screen area can be selected or deselected such that selection causes the selected member to appear in the third screen area and de-selection causes the member to be removed from the third screen area; and
an activation device whereby selection of the activation device either:
creates a relationship in the data store between the member selected in the second portion of the first screen area and the members in the third screen area; or
transmits the data selected in the second portion of the first screen area to the members in the third screen area.

2. A user interface in accordance with claim 1, wherein the selection device to select the group of users or type of data to be published in the first portion of the first screen area comprises a set of buttons, each of said buttons of the first set referencing a group or a data type.

3. A user interface in accordance with claim 1, wherein said display of members of the selected group or data of the selected type comprises a first list displayed in the second portion of the first screen area.

4. A user interface in accordance with claim 1 wherein, said display of the members of the selected group in the second portion of the second screen area comprises a second list displayed in the second portion.

5. A user interface in accordance with claim 4, wherein members selected from the second list in the second screen area are displayed in a third list in the third screen area.

6. A user interface in accordance with claim 5, wherein selection or de-selection of members displayed in the second portion of the second screen area is effected by selector buttons provided adjacent members in the second list in the second screen area and de-selection buttons provided adjacent the members in the third list in the third screen area.

7. A user interface in accordance with claim 1, wherein the activation device comprises a save button in the first screen area.

8. A user interface in accordance with claim 1 further comprising a device to create new members or new data to be published in second portion of the first screen area.

9. A user interface in accordance with claim 8, wherein the device to create new members of new data comprises a new button in the first screen area.

10. A user interface in accordance with claim 1, wherein the user interface is accessible via a browser interface.

11. A user interface in accordance with claim 1, wherein one or more of the users is provided with a website and operation of the activation device causes publication of the data on the websites of the users listed on the third screen area.

12. A user interface in accordance with claim 10, wherein a link is provided adjacent each of the users listed on the third screen area and selection of the link causes display of the website of the user.

13. A user interface in accordance with claim 11, wherein websites are provided with areas in which website users can publish data related to the data published via the activation device.

14. A user interface in accordance with claim 13, wherein the related data published on a website by a user can be viewed in the first screen area by selection of said user from the third list in the third screen area.

15. A user interface in accordance with claim 1, wherein the data to be published can be transmitted to the users as email.

16. A user interface in accordance with claim 1, wherein the first screen area comprises a central screen area, the second screen area comprises a left screen area and the third screen area comprises a right screen area.

17. A user interface in accordance with claim 1, wherein the first portion of the first screen area is located adjacent the top of the first screen area and the second portion of the first screen area is located below the first portion of the first screen area.

18. A user interface in accordance with claim 1, wherein the first portion of the second screen area is located adjacent the top of the second screen area and the second portion of the second screen area is located below the first portion of the second screen area.
